(19) United States
(12) Patent Application Publication
(10) Pub. No.: US 2012/0224801 A1
(43) Pub. Date: Sep. 6, 2012

(54) FIBER OPTIC SEALING APPARATUS

(75) Inventors: Malcolm S. Laing, Blacksburg, VA (US); Daniel S. Homa, Blacksburg, VA (US); Robert M. Harman, Troutville, VA (US)

(73) Assignee: BAKER HUGHES INCORPORATED, Houston, TX (US)

(21) Appl. No.: 13/040,468

(22) Filed: Mar. 4, 2011

(51) Int. Cl. G02B 6/10; G02B 6/36

(52) U.S. Cl. 385/12; 385/94

(57) ABSTRACT

An optical fiber seal includes: an annular layer bonded to an outer glass layer of a length of an optical fiber; and a glass sealing layer bonded to an outer surface of the annular layer and configured to withstand conditions in a downhole environment, the glass sealing layer configured to hermetically seal the length of the optical fiber.

### BACKGROUND

Optical fibers have various uses, such as in communication, lasing and sensing. For example, optical fiber sensors are often utilized to obtain various surface and downhole measurements, such as pressure, temperature, stress and strain, and can also be used as communication cables to transmit data and commands between downhole components and/or between downhole and surface components.

Optical fibers and optical fiber cables deployed downhole are often exposed to very harsh environments. High temperatures, pressures and downhole fluids can cause damage and/or compromise performance of fibers' communication and sensing functions. For example, fiber materials can react with high temperatures and pressures, which can compromise performance by causing attenuation, melting or cracking.

### SUMMARY

An optical fiber seal includes: an annular layer bonded to an outer glass layer of a length of an optical fiber; and a glass sealing layer bonded to an outer surface of the annular layer and configured to withstand conditions in a downhole environment, the glass sealing layer configured to hermetically seal the length of the optical fiber.

An apparatus for estimating at least one parameter includes: an optical fiber sensor including at least one measurement location disposed therein; a housing configured to isolate the optical fiber sensor from an environmental parameter; an annular layer bonded to an outer glass layer of the optical fiber sensor; and a glass sealing layer bonded to an outer surface of the metallic layer and bonded to the housing, the glass sealing layer configured to hermetically seal the optical fiber sensor to the housing.

### BRIEF DESCRIPTION OF THE DRAWINGS

Referring now to the drawings wherein like elements are numbered alike in the several Figures:

FIG. 1 is an axial cross-sectional view of an embodiment of a sealed optical fiber component;

FIG. 2 is an axial cross-sectional view of another embodiment of a sealed optical fiber component;

FIGS. 3A and 3B are longitudinal and axial cross-sectional views, respectively, of another embodiment of a sealed optical fiber component;

FIG. 4 is a side cross-sectional view of a portion of a fiber optic sensor;

FIG. 5 is a side cross-sectional view of a portion of the fiber optic sensor of FIG. 4;

FIG. 6 depicts a downhole measurement apparatus incorporating the fiber optic sensor of FIGS. 4 and 5; and

FIG. 7 is a flow chart illustrating an exemplary method of manufacturing a sealed optical fiber component.

### DETAILED DESCRIPTION

Optical fiber seals, apparatuses utilizing fiber optic seals and methods for manufacturing sealed optical fiber components are shown. An exemplary optical fiber component includes a single mode or multi-mode optical fiber having a metallized layer and/or is coated with an annular layer. In one embodiment, a cladding or other outer glass layer of the optical fiber is coated with one or more metallic, carbon, ceramic or other protective materials by, for example, a deposition process. A glass sealing material is bonded to an exterior surface of the protective annular layer. A method of manufacturing a hermetically sealed optical fiber component includes disposing one or more annular layers on a glass optical fiber via a deposition process such as an electron beam deposition process, and soldering or otherwise bonding or fusing a glass layer onto the outer surface of the annular layer(s) to form a hermetically sealed optical fiber.

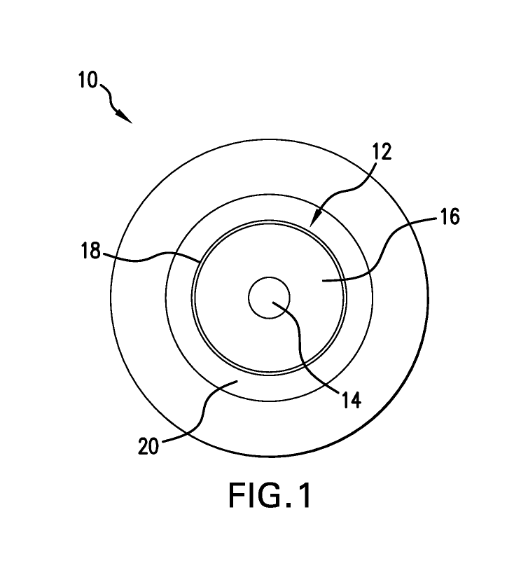

Referring to FIG. 1, an exemplary optical fiber component 10 includes an optical fiber 12 having a hermetically sealed length. The optical fiber 12 includes a core 14 and a cladding 16, which may be made from suitable optically conductive materials including glasses such as silica glass or quartz. In one embodiment, the core 12 is a pure silica core. The optical fiber 12 may be a single mode fiber (SMF) having a core 14 with a constant index of refraction or may be a multi-mode fiber having a core 14 with a constant or graded index of refraction. The optical fiber 12 may have any suitable numerical aperture (NA), for example, greater than or equal to 0.12, or less than 0.12. One or more additional cladding layers and/or other glass layers may surround the cladding 16. A protective annular layer 18 surrounds the optical fiber 12 and is, in one embodiment, bonded with the cladding 16 or other outer glass layer. A glass sealing layer 20 is disposed on and/or bonded to an outer surface of the annular layer 18 and provides a hermetic seal around the optical fiber 12. In one embodiment, the glass sealing layer 20 is disposed between the annular layer 18 and an outer sleeve or housing 22, such as a stainless steel or other metal housing. The housing 22 may be made from materials such as metal or ceramic materials. An example of the housing 22 is a steel or stainless steel sleeve such as a 17-4 PH ferrule. As described herein, an optical fiber component includes any device, such as a downhole tool or component, a sensor, a communication device or a cable, that includes an optical fiber. The optical fiber components are not limited to those described herein, and may be any device suitable for use in downhole conditions.

The optical fiber component 10 includes a seal configured to protect the optical fiber 12 from damage, degradation, loss or failure due to high temperatures, pressures and/or other conditions that can be found in harsh environments, such as downhole environments. The seal includes the annular layer 18, which is disposed between the optical fiber's outer glass layer and the glass sealing layer 20, and is deposited and/or bonded to an exterior surface of the cladding 16 or other parts of the optical fiber 12 (e.g., additional cladding layers or exterior coatings).

The annular layer 18 is configured to protect the optical fiber 12 from signal losses and/or damages resulting from stresses on the optical fiber 12 and/or interactions between the glass sealing layer 20 and the optical fiber 12. In one embodiment, the annular layer 18 is made from a material having a relatively high modulus of elasticity (e.g., greater than the modulus of elasticity of at least the cladding 16 or other outer glass layer of the optical fiber 12). Such a material can serve to reduce the stress on the optical fiber 12 as well as reduce microbend losses resulting from an interface between the glass sealing layer 20 and the optical fiber 12.

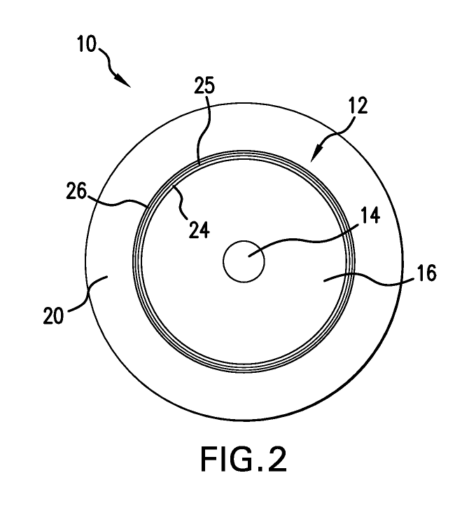

In one embodiment, the annular layer 18 includes a single metallic material or multiple constituent metallic layers. Examples of such metallic layers 18 include titanium, platinum and gold. In one embodiment, shown in FIG. 2, the metallic layer 18 includes an interior titanium layer 24, an intermediate platinum layer 25 and an outer gold layer 26. The order of layers 24, 25 and 26 is not limited to that shown, and maybe changed as desired. The metallic layer 18 may be deposited on and/or bonded to the cladding 14 by any suitable methods, such as deposition or dip-coating methods. An example of a deposition method is an electron beam deposition method. The metallic layers are not limited to those described herein. For example, any suitable metallic material may be included in the metallic layer 18, such as those having a melting point greater than the glass transition temperature of the sealing layer 24. Other examples include aluminum and aluminum alloys, copper, nickel, steel, stainless steel and/or alloys such as alloy 42, alloy 52, invar alloys and kovar alloys. In one embodiment, the metallic layer 18 is coated with an anti-oxidation layer such as an outer gold layer.

In one embodiment, the annular layer 18 includes relatively high modulus of elasticity materials such as carbon and/or ceramic material. Examples of suitable ceramic materials include alumina (Al₂O₃), zirconia (ZrO₂), silicon carbide (SiC) and silicon nitride (Si₃N₄). Such materials are useful for, e.g., reducing microbend losses due to the optical fiber/glass seal interface. The annular layer 18 is not limited to the materials and configurations described herein, and may be made from one or a combination of any of the materials described herein.

A glass sealing layer 20 or coating is disposed on an outer surface of the annular layer 18. The annular layer 18 and the glass sealing layer 20 provide a hermetic seal around the optical fiber 12 to protect the optical fiber 12 from environmental conditions and/or seal the optical fiber 12 to the housing 22. In addition, the glass sealing layer 20 aids in protecting the optical fiber from elevated temperatures that can be found, for example, in a downhole environment. The glass sealing layer 20 is made from a glass material such as commercially available Diemat DM2995. In one embodiment, the glass sealing layer 20 is made from one or more materials that are capable of withstanding downhole conditions such as downhole temperatures and pressures. For example, the glass seal layer material is capable of withstanding temperatures of at least about 200 deg C. and at least 200 PSI. In one embodiment, the glass material is a material having a soldering temperature or a glass transition temperature (Tg) that is greater than downhole temperatures, such as temperatures of about 200 degrees C. or 250 degrees C. In one embodiment, the seal material has a glass transition temperature of at least about 350 degrees C. Other glass sealing materials include commercially available Diemat DM2700, DM2760, and 114 PH from Asahi glass.

In one embodiment, the glass sealing layer 20 is a solder glass configured to solder the annular layer 18 to the housing 22. The solder glass has a solder temperature that is greater than, for example, temperatures in a downhole environment. As described herein, “solder temperature” refers to a temperature at or above the melting point or Tg of the solder glass. An example of a suitable solder glass is lead borate solder glass.

The specific materials making up the core 14, cladding 16, glass sealing layer 20 and dopants are not limited to those described herein. Any materials sufficient for use in optical fibers and/or suitable for affecting numerical apertures may be used as desired. In addition, the diameters or sizes of the optical fiber 12, core 14, cladding 16 and glass sealing layer 20 are not limited, and may be modified as desired or required for a particular design or application. For example, the outside diameter of the optical fiber 12 can range from about 10 microns to about 1000 microns. Optical fibers having diameters greater than or equal to about 125 microns may be used, as well as optical fibers having diameters of less than 125 microns. Other configurations include a multiple core fiber, multiple glass fibers having a surrounding metallic or other annular layer and multiple coated optical fibers surrounded by glass sealing materials.

In one embodiment, the optical fiber 12 is utilized in downhole environments to perform various functions, such as communication and sensing. In one embodiment, the optical fiber 12 is configured as an optical fiber sensor for estimating environmental parameters such as downhole temperature and/or pressure. In this embodiment, the optical fiber 12 includes at least one measurement location disposed therein. For example, the measurement location includes a fiber Bragg grating disposed in the core 12 that is configured to reflect a portion of an optical signal as a return signal, which can be detected and/or analyzed to estimate a parameter of the optical fiber 12 and/or a surrounding environment. Other measurement locations may include reflectors such as mirrors and Fabry-Perot interferometers, and scattering sites such as Rayleigh scattering sites.

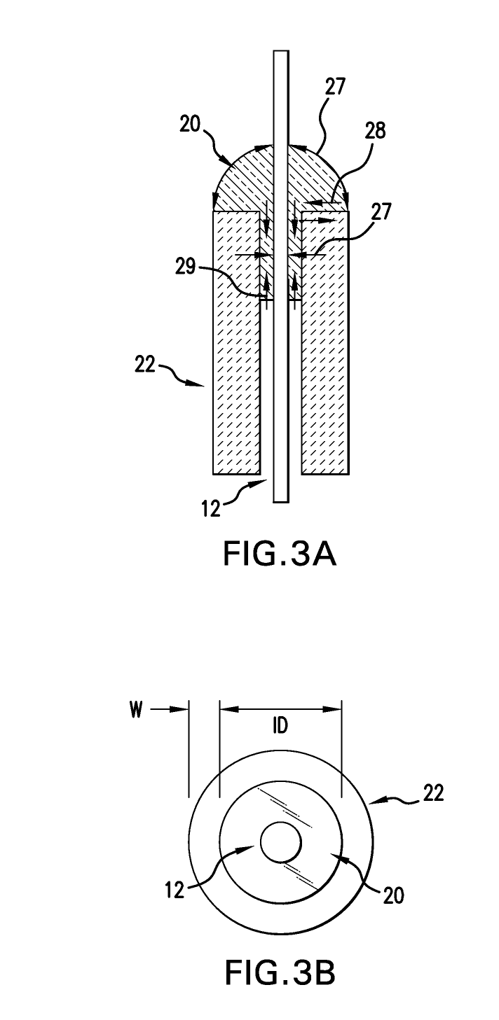

The protective annular layer 18 provides numerous advantages, including protecting the optical fiber 12 from stresses exerted by the glass sealing layer 20 and preventing losses from such stresses and from microbends formed due to an interface between the outer glass layer of the fiber 12 and the glass sealing layer 20. FIGS. 3A and 3B show an exemplary sealing configuration that is provided to illustrate examples of stresses and these advantages. Additional description of sealing stresses are further described in Raymond L. Dietz, “Sealing optical fibers without metallization: design guidelines,” Proc. SPIE Vol. 5454, 111 (2004), which is hereby incorporated by reference in its entirety.

FIGS. 3A and 3B show a portion of an optical fiber package assembly that includes the optical fiber 12, which is sealed to the housing 22 (e.g., a metal tube) by a glass sealing layer 20, which in this example is a glass perform. The assembly is typically made by stripping the optical fiber 12, inserting it into the metal tube and placing the glass perform around the optical fiber 12 and on the top surface of the metal tube. The glass perform is heated to its melting temperature, and then collapses around the fiber and migrates into the interior of the metal tube. The glass perform is then allowed to cool and solidify.

Solidification introduces numerous stresses to the optical fiber 12. For example, radial stresses 27 are formed within the dome created by the sealing glass due to thermal expansion of the glass. Shear stresses 28 at the top surface of the metal tube and axial stresses 29 along the inside wall of the metal tuber result from differences in the coefficient of thermal expansion (CTE) between the sealing glass 20 and the metal tube.

Within the inside diameter of the metal tube, the compressive stress against the optical fiber 12 is a function of the inside diameter (ID) of the tube, the thermal expansion of the tube, and the wall thickness (W) of the tube. The glass properties of transformation temperature (Tg), Young's modulus (E), and the coefficient of thermal expansion (CTE), also impact the radial stress (Sg) in the sealing glass 20. For example, a typical Kovar ferrule with a fiber sealed in the ID or bore of the tube, the radial stress within the sealing glass 20 can be expressed by the following relationship:

$${S}_{g} = \frac{2 {aE}_{m} ( Δ CTE ) Δ T}{1 + 2 ab}$$

Where
a=ID/W
b=Eₘ/E_{g}
ΔCTEₘΔCTE_{g}
ΔT=T_{g}—room temp
Eₘ=Young's modulus of metal ferrule
E_{g}=Young's modulus of glass

As the inside diameter is increased, the stress (Sg) in the sealing glass results in a tensile stress until eventually the glass separates from the inside wall of the tube. As shown in the above relationship, increased wall thickness will reduce (Sg), as will decreasing the Young's modulus of either the glass (Eg) or tube material (Em).

The higher the glass transition temperature of the sealing glass 20 and the greater the difference in CTE, the greater the stress that is imparted on the fiber 12. These stresses can cause induced attenuation and damage such as cracking. The use of a protective coating or layer 18 between the optical fiber 12 and the glass seal (e.g., gold and/or other metals) can help can help reduced the stress on the fiber.

In addition, micro-deformations at the interface between the sealing glass 20 and the optical fiber surface can cause unacceptable microbend losses. These microbend losses can be reduced by increasing the diameter of the optical fiber 12, increasing the numerical aperture, and/or using a coating (i.e., the annular layer 18) with a high modulus of elasticity. For example, use of a relatively hard coating in at least part of the annular layer, such as carbon and/or ceramic materials, can dramatically reduce the associated microbend losses.

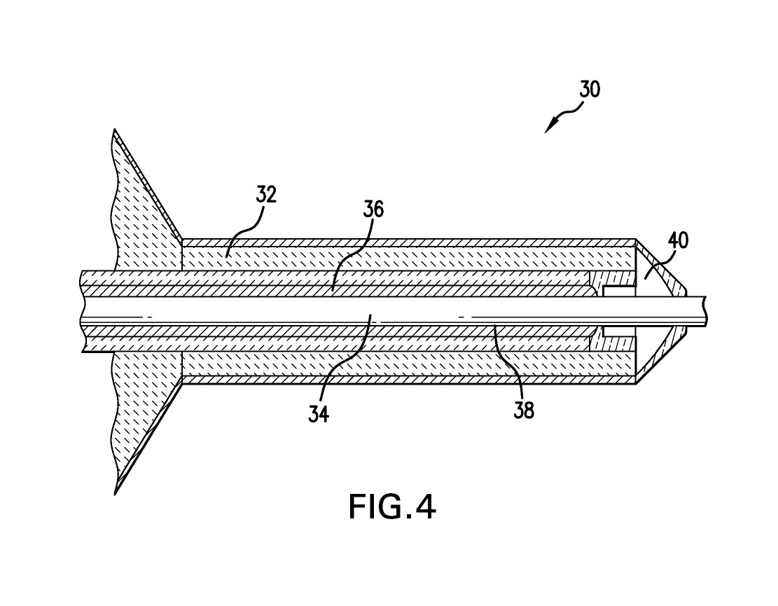

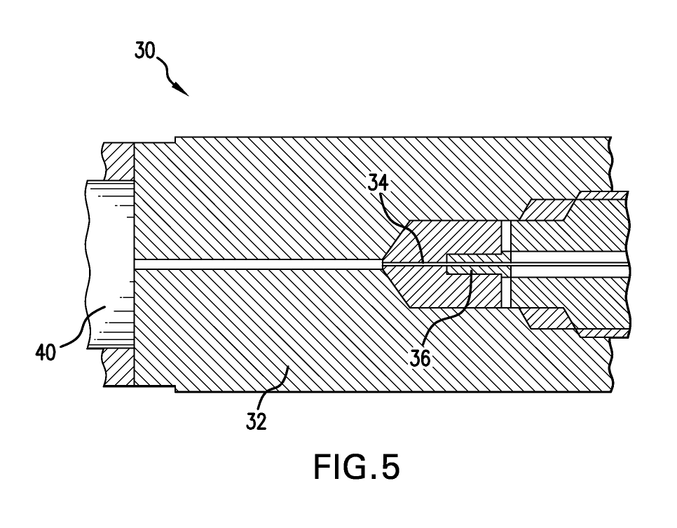

An example of a fiber optic sensor 30 is shown in FIGS. 4 and 5. The sensor 30 includes a metal body or housing 32 configured to house a length of an optical fiber 34 within and isolate the length of the optical fiber 34 from external pressures. The housing 32 forms a cavity 36 within which the length of the optical fiber 34 is disposed. At least a portion of the optical fiber is coated, i.e., includes an external annular (e.g., metallic, ceramic and/or carbon) layer 38 that is disposed between the optical fiber's glass layers and a glass seal 40, at least part of which forms a sealing layer between the coated fiber length and the housing 32. For example, the optical fiber 34 is coated at least along the length of the optical fiber 34 that is in contact with the glass seal 40. The cavity 36 is maintained at a selected pressure by, for example, maintaining the cavity 36 at a vacuum or near vacuum, or filling the cavity with air or other gases, liquids, gels and/or solid materials. Examples of such filler materials include silicon gel, Krytox and hydrocarbon based oils. Such materials are configured to maintain a consistent pressure within the cavity 36 and isolate the optical fiber length from external pressures. In one embodiment, the filler materials are configured to transfer parameters such as temperature and/or pressure from the downhole environment (e.g., downhole fluids or sample fluids).

The optical fiber 34 is in operable communication with a mechanism for transferring downhole parameters to the optical fiber length within the cavity 36. such as an actuator 40. For example, the actuator is configured to transfer temperature and/or pressure from the downhole environment, a sample or materials or components such as a borehole string or downhole fluid. Examples of the actuator 40 include a diaphragm, bellows or other mechanical device that is exposed to pressure from a borehole and transfers the pressure to the optical fiber 34. Measurement locations, such as mirrors, changes in material refractive index, discontinuities in the optical fiber, Bragg grating, Fabry-Perot cavities, etc. cause a change in a reflected signal from the optical fiber 34.

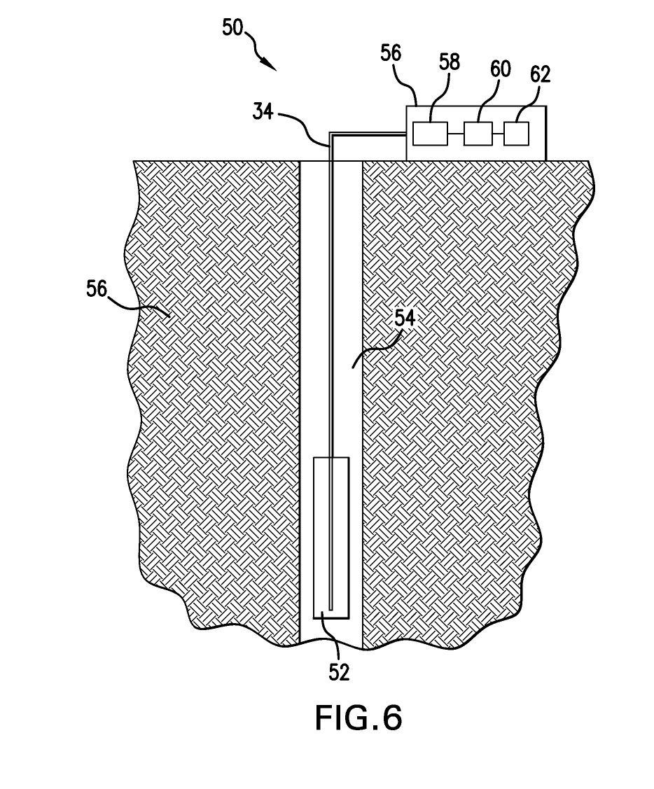

An example of an application of the optical fiber component 10 and/or the optical fiber sensor 30 is shown in FIG. 6, which illustrates a borehole monitoring, sensing, exploration, drilling and/or production system 50. The system 50 includes a downhole tool 52 disposed in a borehole 54 in an earth formation 56. The tool 52 may be configured as a downhole measurement apparatus for measuring various downhole parameters, such as strain, stress, temperature, vibration and pressure. The tool 52 includes, for example, the optical fiber sensor 30. In one embodiment, the optical fiber 34 is operably connected to a processing unit, such as a surface processing unit 56.

In one embodiment, the surface processing unit 56 includes an interrogation source such as a tunable laser 58, a detector 60 and a processing unit 62. The detector 60 may be any suitable type of photodetector such as a diode assembly. The detector 60 is configured to receive return signals reflected from measurement units (e.g., FBGs) in the length of the optical fiber 34 disposed in the cavity 36. The processing unit 62 is configured to receive and/or generate data from the detector 60, and may also be configured to communicate the data and/or analyze the data to estimate downhole parameters, such as temperature or pressure, based on changes in the optical fiber 34.

In one embodiment, the optical fiber sensor 30 and/or the optical fiber component 10 is disposed on or in relation to a carrier, such as a drill string segment, downhole tool or bottomhole assembly. As described herein, “borehole” or “wellbore” refers to a single hole that makes up all or part of a drilled well. In addition, it should be noted that “carrier” as used herein, refers to any structure suitable for being lowered into a wellbore or for connecting a drill or downhole tool to the surface, and is not limited to the structure and configuration described herein. Examples of carriers include casing pipes, wirelines, wireline sondes, slickline sondes, drop shots, downhole subs, BHA's, drill string inserts, modules, internal housings and substrate portions thereof.

The downhole tool 52 and/or the optical fiber sensor 30 may be used in conjunction with methods for estimating various parameters of a borehole environment.

For example, a method includes disposing the optical fiber sensor 30 downhole, emitting a measurement signal from the laser 58 and propagating the signal through the optical fiber 34. Measurement units in the optical fiber 34 reflect a portion of the signal back to the surface unit 56 through the optical fiber 34. The wavelength of this return signal is shifted relative to the measurement signal due to parameters such as, pressure, strain and temperature. The return signal is received by the surface unit 56 and is analyzed to estimate desired parameters.

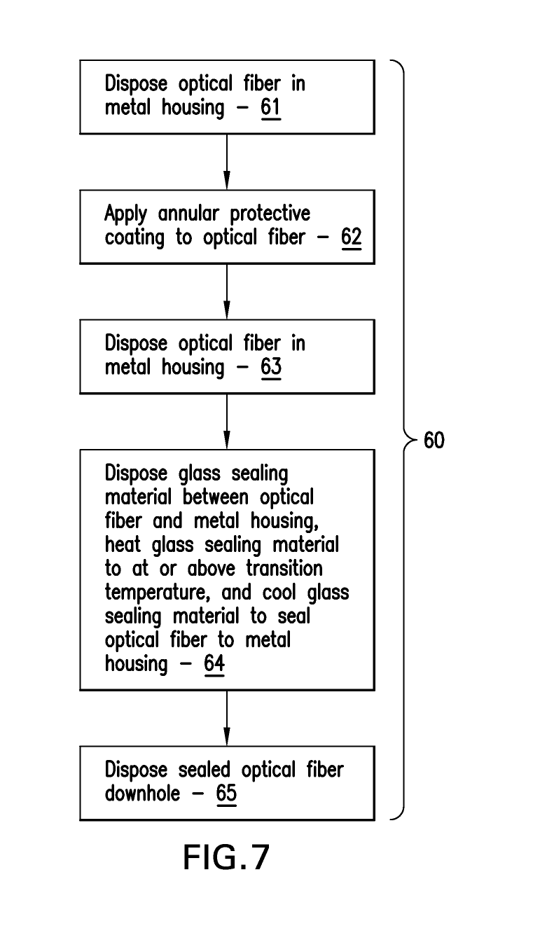

FIG. 7 illustrates a method 60 of manufacturing the optical fiber component 10. The method 60 includes one or more stages 61-64. In one embodiment, the method 60 includes the execution of all of stages 61-64 in the order described. However, certain stages may be omitted, stages may be added, or the order of the stages changed.

In the first stage 61, an optical fiber 12 is obtained or manufactured. In one embodiment, a preform is manufactured utilizing any of a variety of suitable methods. Such methods include deposition methods such as chemical vapor deposition (CVD), modified chemical vapor deposition (MCVD), plasma chemical vapor deposition (PCVD), vapor-phase axial deposition (VAD) and outside vapor deposition (OVD). A length of optical fiber is drawn from the preform. The optical fiber 12 includes a core and cladding layer, and may also include additional layers such as additional cladding layers and/or protective coatings. The optical fiber 12 may also include multiple cores as desired.

In the second stage 62, the optical fiber 12 is coated by disposing and/or bonding a metallic, ceramic, carbon and/or other protective material to the outer surface of the cladding or other outermost surface of the optical fiber, creating an annular layer 18. In one embodiment, multiple metallic layers including materials such as concentric layers of titanium, platinum and/or gold are successively deposited on the outer glass layer of the optical fiber 12, for example, by a deposition process such as electron beam deposition. A carbon and/or ceramic coating may also be included in the annular layer 18. In other embodiments, a protective material such as a copper alloy or metal can be coated on the fiber during the fiber drawing process.

In the third stage 63, a glass sealing layer 20 is applied to the outer surface of the annular layer 18. In one embodiment a solder glass is applied by heating the solder glass to a temperature above its glass transition temperature and then cooling the solder glass to bind the solder glass to the annular layer 18 and form the glass sealing layer 20. For example, the coated optical fiber is fed into a glass ferrule, frit or other perform, and the glass preform is heated to above its transition temperature and then cooled to solidify a glass layer around the coated layer. In one embodiment, the glass preform is heated in an induction furnace at, e.g., about 600 deg C.

In one embodiment, the glass sealing layer 20 is applied between the annular layer 18 and an additional outer layer, such as a stainless steel sleeve or other housing 22. For example, the coated optical fiber may be ran or inserted into a stainless steel (e.g., 17-4 PH) or other ferrule, and solder glass in a powder or paste form is disposed therebetween and heated to above the solder glass' transition temperature to soften and form the glass layer, which acts to bind the housing 22 to the annular layer 18. In another embodiment, a glass solder frit or preform is fed or otherwise disposed in between the coated fiber and the metal housing 22.

Various methods of heating may be used to form a hermetic seal around the fiber via the outer glass layer 20. In one example, the glass layer 20 is indirectly heated by first heating the housing 22. The heated housing 22 in turn heats the sealing and/or solder glass. The housing 22 can be heated, e.g., by conduction heating, resistance heating or induction heating, in which an RF power supply provided current to induction coils that produce an RF magnetic field to heat the housing 22. Other heating methods include directly heating the glass by, e.g., radiant heating, hot air or gas, or laser heating.

In the fourth stage 64, the now hermetically sealed optical fiber is optionally disposed to a downhole location via a suitable carrier, such as the tool 52, a wireline and/or a borehole string. The sealed optical fiber may be utilized to perform various downhole functions, such as sensing formation, downhole fluid and/or downhole component parameter and communication.

The optical fibers, apparatuses and methods described herein provide various advantages over existing methods and devices. For example, a hermetically sealed optical fiber is provided that can transmit a clean low loss optical signal at high temperatures and pressures experienced downhole, such as temperatures of at least about 350 degrees C. and at least about 5000 PSI.

The annular layer provides protection from the glass sealing layer or glass frit, and allows glass sealing materials having higher Tg temperatures to be used, which in turn allows for use of the materials in downhole environments with higher temperatures. As the Tg temperature of the glass increases, the compressive strain that is exerted by the seal, as the seal cools, increases. The annular layer is configured to withstand such compressive stresses, prevent cracking, reduced microbend losses or other damage to the optical fiber. The annular layer may also provide protection from microbend losses without the need to increase the diameter of the optical fiber and/or increase the numerical aperture, which can allow for reduced packaging sizes, complexity and cost.

In connection with the teachings herein, various analyses and/or analytical components may be used, including digital and/or analog systems. The apparatus may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. An optical fiber seal comprising:
an annular layer bonded to an outer glass layer of a length of an optical fiber; and
a glass sealing layer bonded to an outer surface of the annular layer and configured to withstand conditions in a downhole environment, the glass sealing layer configured to hermetically seal the length of the optical fiber.

2. The optical fiber seal of claim 1, wherein the annular layer has a higher modulus of elasticity than the outer glass layer.

3. The optical fiber seal of claim 1, wherein the annular layer is configured to prevent damage to the optical fiber from compressive stress exerted on the optical fiber by the glass sealing layer.

4. The optical fiber seal of claim 1, wherein the annular layer includes at least one of a metallic layer, a carbon layer and a ceramic layer.

5. The optical fiber seal of claim 1, wherein the metallic layer is selected from at least one of titanium, platinum and gold.

6. The optical fiber seal of claim 5, wherein the metallic layer includes an interior titanium layer, an intermediate platinum layer surrounding the interior titanium layer, and an outer gold layer surrounding the intermediate platinum layer.

7. The optical fiber seal of claim 1, wherein the glass sealing layer has a glass transition temperature that is greater than a downhole temperature.

8. The optical fiber seal of claim 1, wherein the glass sealing layer includes a solder glass.

9. The optical fiber seal of claim 1, further comprising a housing having a portion that surrounds the length of the optical fiber and is bonded to the glass sealing layer.

10. The optical fiber seal of claim 1, wherein the optical fiber is configured as an optical fiber sensor and includes at least one measurement unit disposed therein.

11. The optical fiber seal of claim 10, wherein the glass sealing layer is bonded to a housing configured to isolate at least a portion of the optical fiber sensor from a downhole parameter, and the glass sealing layer is configured to hermetically seal the optical fiber to the housing.

12. An apparatus for estimating at least one parameter, the apparatus comprising:
an optical fiber sensor including at least one measurement location disposed therein;
a housing configured to isolate the optical fiber sensor from an environmental parameter;
an annular layer bonded to an outer glass layer of the optical fiber sensor; and
a glass sealing layer bonded to an outer surface of the annular layer and bonded to the housing, the glass sealing layer configured to hermetically seal the optical fiber sensor to the housing.

13. The apparatus of claim 12, wherein the annular layer has a higher modulus of elasticity than the outer glass layer.

14. The apparatus of claim 12, wherein the annular layer is configured to prevent damage to the optical fiber from compressive stress exerted on the optical fiber by the glass sealing layer.

15. The apparatus of claim 12, wherein the annular layer includes at least one of a metallic layer, a carbon layer and a ceramic layer.

16. The apparatus of claim 15, wherein the metallic layer is selected from at least one of titanium, platinum and gold.

17. The apparatus of claim 16, wherein the metallic layer includes an interior titanium layer, an intermediate platinum layer surrounding the interior titanium layer, and an outer gold layer surrounding the intermediate platinum layer.

18. The apparatus of claim 12, wherein the environmental parameter is a pressure within a borehole in an earth formation.

19. The apparatus of claim 12, further comprising an actuator mechanism configured to transmit the environmental parameter to the optical fiber sensor.

20. The apparatus of claim 12, further comprising:
a light source configured to send an optical signal into the optical fiber sensor; and
a detector configured to receive a return signal generated by the at least one measurement location and generate data representative of the at least one parameter.
